(19) United States
(12) Patent Application Publication
(10) Pub. No.: US 2020/0136175 A1
(43) Pub. Date: Apr. 30, 2020

(54) CYLINDRICAL LITHIUM-ION BATTERY

(71) Applicant: CHANGSHA JUNENGCHONG NEW ENERGY CO., LTD, Changsha (CN)

(72) Inventor: BO-QIAN QIU, Changsha (CN)

(21) Appl. No.: 16/727,712

(22) Filed: Dec. 26, 2019

Related U.S. Application Data
(63) Continuation of application No. PCT/CN2018/093103, filed on Jun. 27, 2018.

(30) Foreign Application Priority Data
Jun. 28, 2017 (CN) 201710511981.X

(51) Int. Cl. H01M 10/0525; H01M 4/04; H01M 10/6551; H01M 10/04

(52) U.S. Cl. CPC H01M 10/0525; H01M 4/0404; H01M 2004/027; H01M 10/0477; H01M 10/6551

(57) ABSTRACT

A cylindrical lithium-ion battery which can maintain working temperature within a certain range includes a battery cell having a positive electrode plate and a negative electrode plate. The negative electrode plate includes a negative current collector and a negative active material layer on the negative current collector. The positive electrode plate includes a positive current collector and a positive active material layer on the positive current collector. The positive electrode plate and/or the negative electrode plate includes a heat conducting and collecting body. The heat conducting and collecting body is a portion of the positive current collector not coated by the positive active material layer or a portion of the negative current collector not coated by the negative active material layer. At least two heat conducting and collecting bodies are stacked together to a heat converging path. A thin-film heater is connected to the heat converging path.

### CROSS-REFERENCE TO RELATED APPLICATIONS

This application claims all benefits accruing under 35 U.S.C. § 119 from China Patent Application No. 201710511981.X, filed on Jun. 28, 2017 in the China National Intellectual Property Administration, the content of which is hereby incorporated by reference. This application is a continuation under 35 U.S.C. § 120 of international patent application PCT/CN2018/093103 filed Jun. 27, 2018.

### FIELD

The subject matter herein generally relates to lithium-ion batteries, and more particularly, to a cylindrical lithium-ion battery.

### BACKGROUND

Traffic on the roads brings pressure on the energy crisis and environmental pollution, thus it is urgent to develop and research efficient, clean and safe new energy vehicles to achieve energy conservation and emission reduction. Lithium-ion batteries have become the best candidates for power systems of the new energy vehicles because of high specific energy, no pollution, and no memory effect. However, the lithium-ion batteries are very sensitive to temperature, and efficient discharge and good performance of the battery pack can be only obtained within a suitable temperature range. Operating at an elevated temperature may cause the lithium-ion battery to age faster and increase its thermal resistances faster. Furthermore, the cycling time becomes less, the service life becomes shorter, and even thermal runaway problems occur at an elevated operating temperature. However, operating at too low a temperature may lower the conductivity of the electrolyte and the ability to conduct active ions, resulting an increase of the impedance, and a decrease in the capacity of the lithium-ion batteries.

Conventionally, the cell is positioned to improve the fluid flow path and increase the heat dissipation. The battery casing may also be improved by replacing the aluminum alloy shell material with the composite of thermoelectric material and aluminum, and by adding a plurality of heat dissipating ribs to the side of the battery casing. The electrode plate may also be extended into the electrolyte to transmit heat energy to the battery casing through the electrolyte and then to the outside environment. Although some heat is dissipated, the heat dissipation efficiency is generally low because the heat cannot be directly discharged from the electrode plates, the main heat generating component, to the outside environment. Therefore, a new design of a cylindrical lithium-ion battery is desired.

### BRIEF DESCRIPTION OF THE DRAWINGS

FIG. 1 is a schematic view of a cylindrical lithium-ion battery in a first embodiment according to the present disclosure.

FIG. 2A is a cross-sectional view of the cylindrical lithium-ion battery of FIG. 1.

FIG. 2B is a cross-sectional view of a positive electrode plate of the cylindrical lithium-ion battery of FIG. 2A.

FIG. 2C is a cross-sectional view of a negative electrode plate of the cylindrical lithium-ion battery of FIG. 2A.

FIG. 3 is a schematic view of a cylindrical lithium-ion battery in a second embodiment according to the present disclosure.

FIG. 4 is a schematic view of a cylindrical lithium-ion battery in a third embodiment according to the present disclosure.

FIG. 5 is a schematic view of a cylindrical lithium-ion battery in a fourth embodiment according to the present disclosure.

FIG. 6 is a schematic view of a cylindrical lithium-ion battery in a fifth embodiment according to the present disclosure.

FIG. 7 is a schematic view of a cylindrical lithium-ion battery in a sixth embodiment according to the present disclosure.

### DETAILED DESCRIPTION

Implementations of the disclosure will now be described, by way of embodiments only, with reference to the drawings.

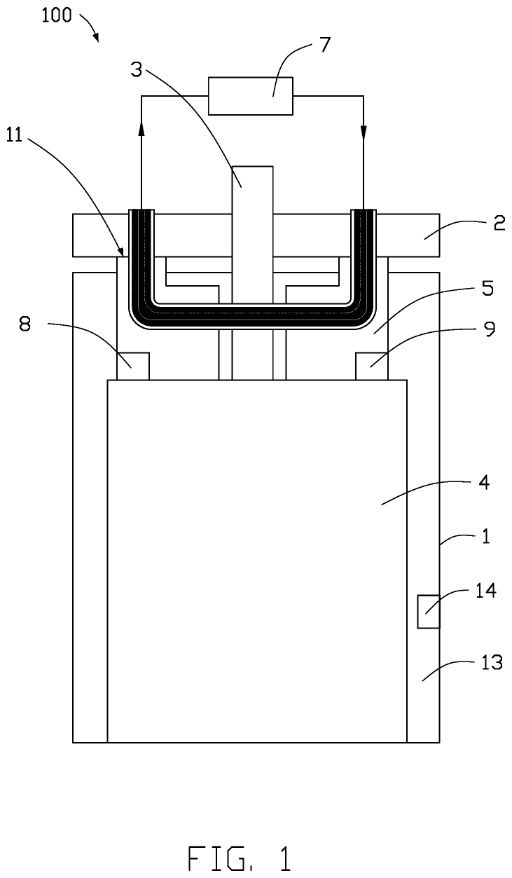

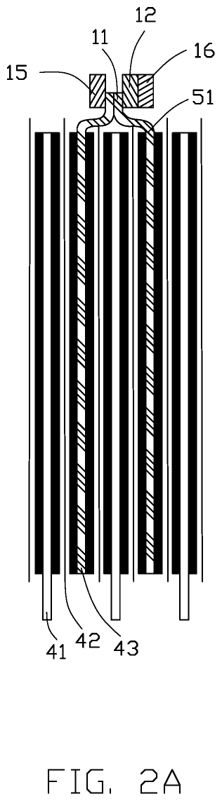

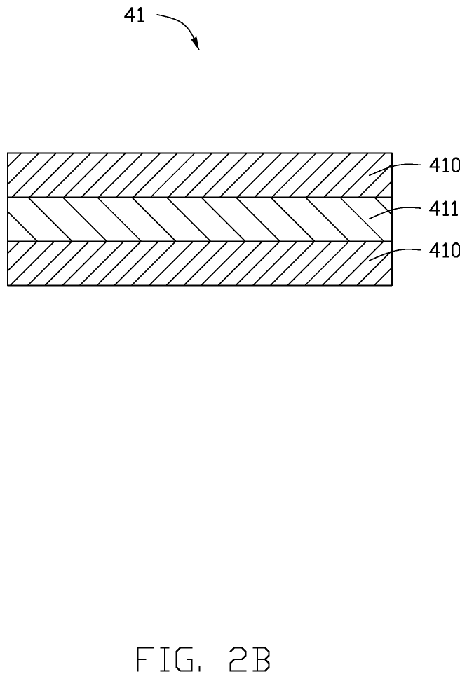

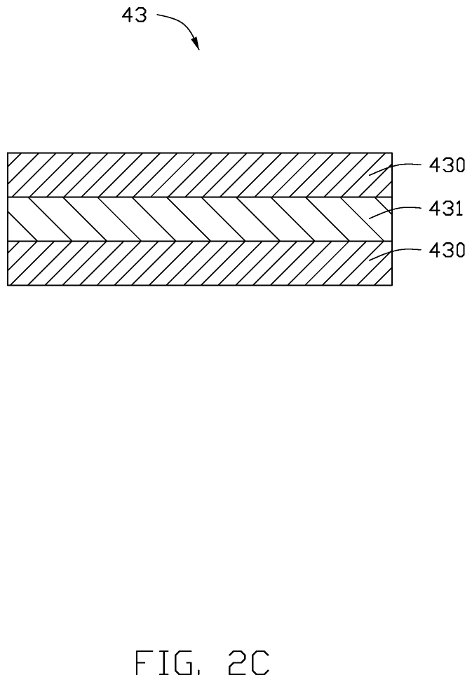

FIGS. 1 and 2A illustrate a first embodiment of a cylindrical lithium-ion battery 100 comprising a cylindrical outer casing 1, a positive cover plate 2, a negative cover plate (not shown), a positive terminal post 3, a negative terminal post (not shown), and a battery cell 4. The positive cover plate 2 and the negative cover plate are disposed at opposite ends of the outer casing 1. The positive terminal post 3 and the negative terminal post are respectively disposed on the positive cover plate 2 and the negative cover plate. The battery cell 4 comprises a positive electrode plate 41, a negative electrode plate 43, and a separator 42 spaced between the positive electrode plate 41 and the negative electrode plate 43. The positive electrode plate 41, the separator 42, and the negative electrode plate 43 are sequentially laminated together and then wound together to form the battery cell 4 in a shape of cylinder. The positive electrode plate 41 comprises a positive electrode tab (not shown), which is connected to the positive terminal post 3. The negative electrode plate 43 comprises a negative electrode tab (not shown), which is connected to the negative terminal post. The positive electrode tab and the negative electrode tab are disposed at one end or opposite ends of the battery cell 4. Referring to FIG. 2B, the positive electrode plate 41 comprises a positive current collector 411 and two positive active material layers 410 coated on the positive current collector 411. Referring to FIG. 2C, the negative electrode plate 43 comprises a negative current collector 431 and two negative active material layers 430 coated on the negative current collector 431.

Referring to FIG. 1, the lithium-ion soft battery 100 further comprises at least two heat conducting and collecting bodies 5 formed on at least one of the positive electrode plate 41 and the negative electrode plate 43. Each heat conducting and collecting body 5 is a portion of the positive current collector 411 not coated by the positive active material layer 410 or a portion of the negative current collector 431 not coated by the negative active material layer 430. The at least two heat conducting and collecting bodies 5 are stacked together to form at least one heat converging path 11, which is configured to transmit heat energy into or out of the battery cell 4. A thin-film heater 8 is disposed on or connected to the heat converging path 11.

By stacking the heat conducting and collecting bodies 5 to form the heat converging path 11 and heating the heat converging path 11 through the thin-film heater 8, the internal temperature of the battery 100 is increased, thereby avoiding low working efficiency and low service life of the battery 100 caused by a low internal temperature. Furthermore, the heat energy can also quickly exit out of the battery 100 through the heat converging path 11, thereby maintaining the temperature of the battery 100 within a suitable range. The heat conducting and collecting body 5 can be integrally formed with the positive electrode plate, which simplifies the manufacturing process and increase the manufacturing efficiency.

In at least one embodiment, the heat conducting and collecting bodies 5 overlap with each other. The heat conducting and collecting bodies 5 are connected together by welding, thereby forming the heat converging path 11. That is, the heat conducting and collecting bodies 5 can be connected together without any extra component. The welding can be ultrasonic welding, laser welding, or friction welding. In another embodiment, the heat conducting and collecting bodies 5 can also be connected together by bolting or riveting.

Moreover, referring to FIG. 2A, the heat conducting and collecting bodies 5 are bent towards each other before connected together. Therefore, the heat absorbed by the heat conducting and collecting bodies 5 is converged, which facilitates dissipating of the heat from the battery 100 or heating of the battery 100. The heat conducting and collecting bodies 5 are bent to be perpendicular to the positive electrode plate 41 or the negative electrode plate 43. The heat conducting and collecting bodies 5 can also be bent to be inclined with the positive electrode plate 41 or the negative electrode plate 43 by an angle between 0 degree to 89 degrees. The heat conducting and collecting bodies 5 can be bent toward different directions (for example, the bending direction of a portion of the heat conducting and collecting bodies 5 being opposite to that of the remaining heat conducting and collecting bodies 5). The entirety of the heat conducting and collecting bodies 5 can also be bent toward a single direction, which facilitates the connection of the heat conducting and collecting bodies 5. In other embodiments, a portion of the heat conducting and collecting bodies 5 are bent toward a single direction or different directions, and the portion which is bent is connected to the remaining portion of the heat conducting and collecting bodies 5. The remaining portion of each of the heat conducting and collecting bodies 5 is straight (unbent).

In other embodiments, the heat conducting and collecting bodies 5 can also be parallel to the positive active material layers 410. That is, the heat conducting and collecting bodies 5 are not bent towards each other.

A fluid-containing pipe 6 is connected to the heat converging path 11. In at least one embodiment, the heat converging paths 11 (fluid-containing pipe 6) can be disposed at an end of the battery 100 having the positive terminal post 3 or opposite to the positive terminal post 3. The heat converging path 11 can also be disposed at a side of the battery 100. When the number of the at least one heat converging paths 11 is greater than one, the heat converging paths 11 disposed at the end of the positive terminal post 3 can be one or more than one.

In at least one embodiment, referring to FIG. 1, the heat conducting and collecting body 5, the fluid-containing pipe 6, and the positive terminal post 3 are disposed at the same end of the battery 100. An inlet and an outlet of the fluid-containing pipe 6 are disposed on different ends of the positive cover plate 2. The inlet and the outlet of the fluid-containing pipe 6 are further connected to a first heat exchanging device 7 outside the battery 100.

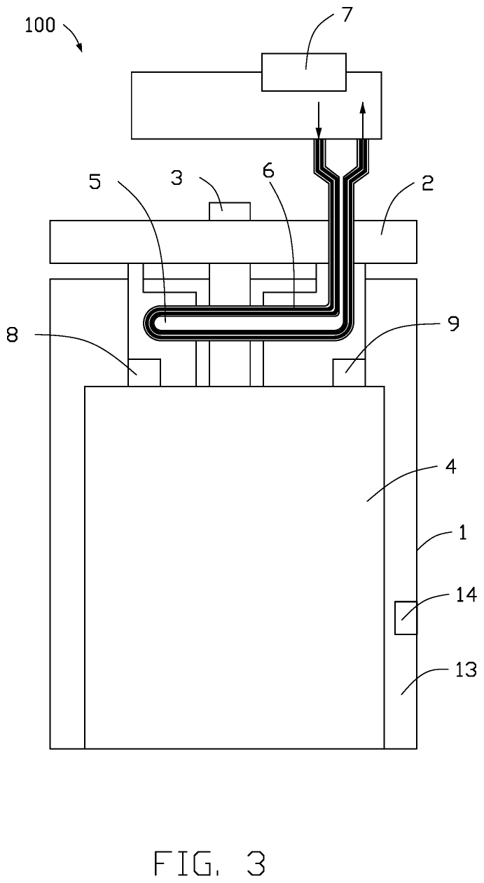

Referring to FIG. 3, in a second embodiment, the heat conducting and collecting body 5, the fluid-containing pipe 6, and positive terminal post 3 are disposed at the same end of the battery 100. The inlet and an outlet of the fluid-containing pipe 6 are disposed on one end of the positive cover plate 2. The inlet and the outlet of the fluid-containing pipe 6 are connected to the first heat exchanging device 7 outside the battery 100.

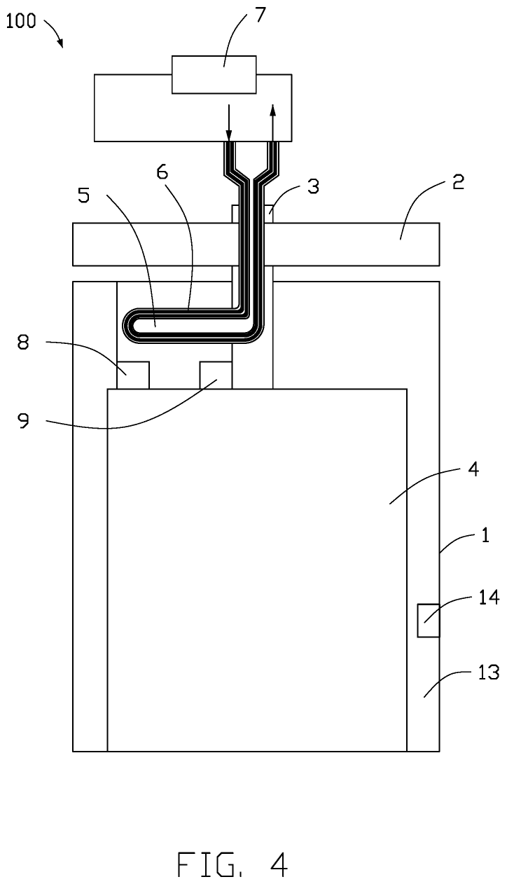

Referring to FIG. 4, in a third embodiment, the heat conducting and collecting body 5, the fluid-containing pipe 6, and the positive terminal post 3 are disposed at one end of the battery 100. The inlet and the outlet of the fluid-containing pipe 6 are both disposed at a center of the positive terminal post 3. The inlet and the outlet of the fluid-containing pipe 6 are connected to the first heat exchanging device 7 outside the battery 100.

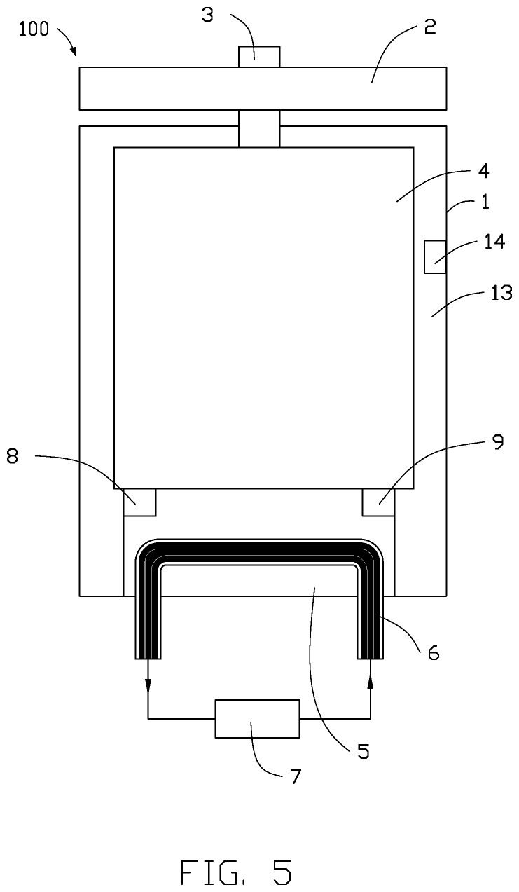

Referring to FIG. 5, in a fourth embodiment, the heat conducting and collecting body 5, the fluid-containing pipe 6, and the negative terminal post are disposed at one end of the battery 100. The inlet and the outlet of the fluid-containing pipe 6 are disposed at different ends of the negative cover plate. The inlet and the outlet of the fluid-containing pipe 6 are connected to the first heat exchanging device 7 outside the battery 100.

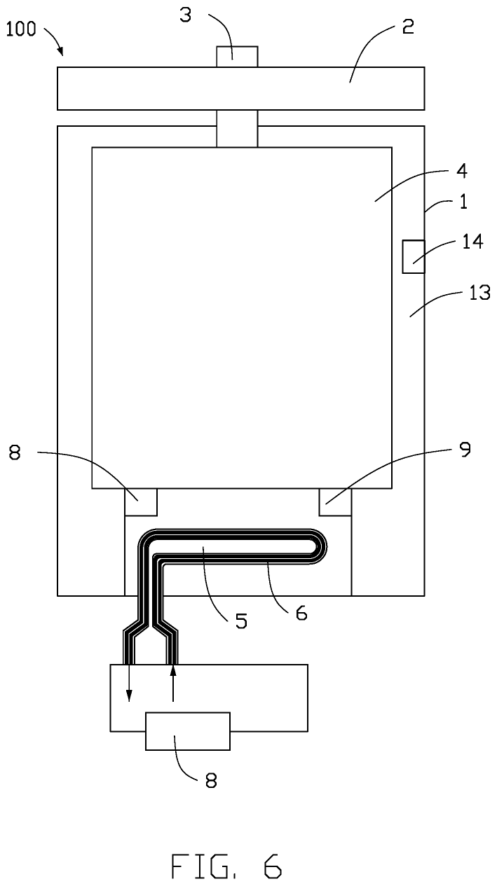

Referring to FIG. 6, in a fifth embodiment, the heat conducting and collecting body 5, the fluid-containing pipe 6, and the negative terminal post are disposed at one end of the battery 100. The inlet and the outlet of the fluid-containing pipe 6 are both disposed on one end of the negative cover plate. The inlet and the outlet of the fluid-containing pipe 6 are connected to the first heat exchanging device 7 outside the battery 100.

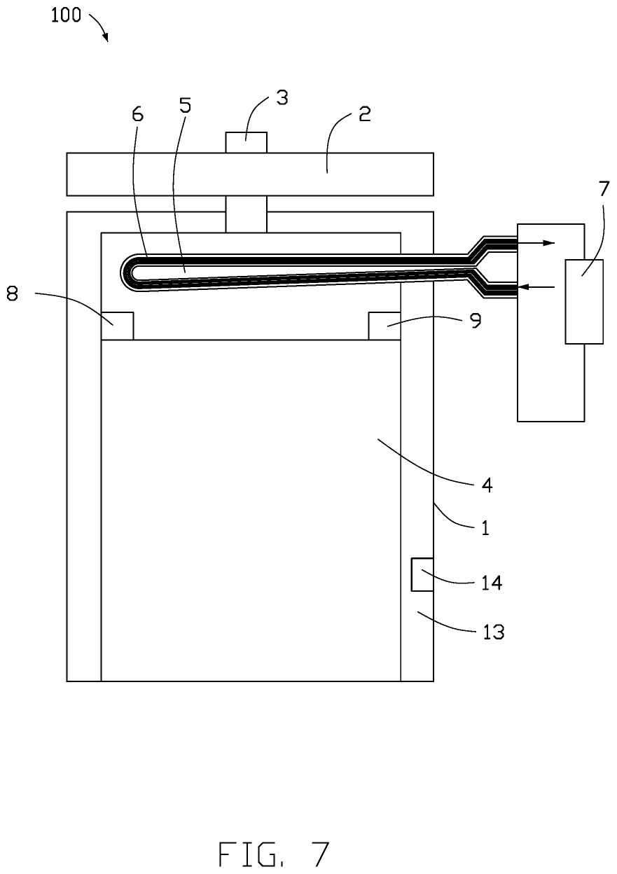

Referring to FIG. 7, in a sixth embodiment, the heat conducting and collecting body 5, the fluid-containing pipe 6, and the positive terminal post 3 are disposed at one end of the battery 100. The inlet and the outlet of the fluid-containing pipe 6 are both disposed at one end of the sidewall of the outer casing 1. The inlet and the outlet of the fluid-containing pipe 6 are connected to the first heat exchanging device 7 outside the battery 100.

In at least one embodiment, at least a portion of the heat conducting and collecting bodies 5 defines a plurality of holes (not shown). The holes can pass through the heat conducting and collecting body 5, and have a mesh structure or a 3D internal structure. In another embodiment, at least a portion of the heat conducting and collecting bodies 5 can define a concave and convex surface. As such, the heat conducting performance of the heat conducting and collecting body 5 is improved.

Referring to FIG. 1, in at least one embodiment, a heat dissipation member 9 is connected to the heat converging path 11. The heat dissipation member 9 can be disposed between the heat conducting and collecting bodies 5. As such, the heat dissipation member 9 can conduct the heat energy out of the heat converging path 11. The heat dissipation member 9 can be multiple fins, a heat sink, or a metal sheet. The metal sheets can quickly conduct the heat energy out of the heat converging path 11. The metal sheet and the heat conducting and collecting body 5 can be made of a same material, which facilitates the connection between the metal sheet and the heat conducting and collecting body 5.

In at least one embodiment, a second heat exchanging device 12 is connected to the heat converging path 11 by welding. The second heat exchanging device 12 can maintain the temperature of the heat converging path 11 within a suitable range, thereby avoiding damages to the battery 100. Furthermore, the heat converging path 11 and the second heat exchanging device 12 are connected together without any extra component, which also facilitates the connection. In another embodiment, the heat converging path 11 and the second heat exchanging device 12 can also be connected together by bolting, gluing, or riveting, which allows the connection to be stable. In another embodiment, the heat converging path 11 can also be directly connected to the outer casing 1. The outer casing 1 then serves as a heat sink to allow the heat energy on the heat converging path 11 to be delivered to the outer casing 1.

In at least one embodiment, the heat conducting and collecting body 5 can have an insulating layer (not shown) on a surface thereof. As such, a short circuit in the battery 100 and concomitant damage can be avoided.

In at least one embodiment, the heat conducting and collecting body 5 can protrude from the positive electrode plate 41, which facilitates the conduction and dissipation of the heat energy. Portions of the heat conducting and collecting body 5 protruding from the positive electrode plate 41 are further inserted into the electrolyte 13 received in the outer casing 1. As such, the heat energy from the heat conducting and collecting body 5 can be conducted into the electrolyte 13 and further to the external surface of the battery 100. Therefore, the heat energy is prevented from being accumulated in the battery 100 due to poor heat conduction of the separator 42. Furthermore, the heat energy in the electrolyte 13 can further quickly move to the positive and the negative electrode plates 41, 43, which prevents the temperature of the positive and the negative electrode plates 41, 43 from being too low. In another embodiment, the heat conducting and collecting body 5 can also be recessed with respect to the negative electrode plate 43, which saves the internal space of the battery 100, and further increases the capacity of the battery 100 in casing of a certain size.

In at least one embodiment, a third heat exchanging device 14 is disposed in the electrolyte 13 for heating or cooling the electrolyte 13. The electrolyte 13 can in turn heat or cool the heat conducting and collecting bodies 5, thereby maintaining the temperature of the battery 100 within a suitable range.

In an embodiment, an interconnecting portion 51 is formed between the heat conducting and collecting body 5 and the negative electrode plate 43. A thickness of the entirety of the heat conducting and collecting body 5 is same of that of the interconnecting portion 51. As such, the heat conducting property of the heat conducting and collecting body 5 is improved, and the manufacturing process is simplified.

In at least one embodiment, a first temperature sensor 15 is disposed on the heat converging path 11, which can sense the temperature of the heat converging path 11. Furthermore, a second temperature sensor 16 is disposed on the second heat exchanging device 12, which can sense the temperature of the second heat exchanging device 12. The first and the second temperature sensors 15, 16 can be thin-film temperature sensors.

In at least one embodiment, the positive active material of the positive active material layer 410 is lithium iron phosphate, lithium cobalt oxide, lithium manganate, or a ternary material. The negative active material of the negative active material layers 430 is carbon, tin-based negative material, transition metal nitride containing lithium or alloy.

Implementations of the above disclosure will now be described by way of embodiments only. It should be noted that devices and structures not described in detail are understood to be implemented by the general equipment and methods available in the art.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A cylindrical lithium-ion battery comprising:
a battery cell comprising a positive electrode plate and a negative electrode plate, the negative electrode plate comprising a negative current collector and a negative active material layer coated on the negative current collector, the positive electrode plate comprising a positive current collector and a positive active material layer coated on the positive current collector; and
at least two heat conducting and collecting bodies formed on at least one of the positive electrode plate and the negative electrode plate, each of the heat conducting and collecting bodies being a portion of the positive current collector not coated by the positive active material layer or a portion of the negative current collector not coated by the negative active material layer;
wherein the at least two heat conducting and collecting bodies are stacked together to form at least one heat converging path, which being configured to transmit heat energy into or out of the battery cell; and
wherein a thin-film heater is connected to the at least one heat converging path.

2. The cylindrical lithium-ion battery of claim 1, wherein the at least two heat conducting and collecting bodies overlap with each other to form the at least one heat converging path.

3. The cylindrical lithium-ion battery of claim 1, wherein the at least two heat conducting and collecting bodies are connected together by welding.

4. The cylindrical lithium-ion battery of claim 3, wherein the welding is ultrasonic welding, laser welding, or friction welding.

5. The cylindrical lithium-ion battery of claim 1, wherein the at least two heat conducting and collecting bodies are connected to each other by bolting or riveting.

6. The cylindrical lithium-ion battery of claim 1, wherein the at least two heat conducting and collecting bodies are bent towards each other.

7. The cylindrical lithium-ion battery of claim 6, wherein the at least two heat conducting and collecting bodies are bent to be inclined with the positive electrode plate or the negative electrode plate by an angle between 0 degree to 90 degrees.

8. The cylindrical lithium-ion battery of claim 6, wherein the at least two heat conducting and collecting bodies are bent toward different directions or a single direction.

9. The cylindrical lithium-ion battery of claim 1, wherein a portion of the heat conducting and collecting bodies are bent toward a single direction or different directions, and the portion which is bent is connected to a remaining portion of the at least two heat conducting and collecting bodies, the remaining portion of each of the heat conducting and collecting bodies is straight.

10. The cylindrical lithium-ion battery of claim 1, wherein at least a portion of the at least two heat conducting and collecting bodies defines a plurality of holes or a concave and convex surface.

11. The cylindrical lithium-ion battery of claim 1, wherein a heat dissipation member is disposed between the at least two heat conducting and collecting bodies, and the heat dissipation member is fins or a heat sink.

12. The cylindrical lithium-ion battery of claim 1, wherein a heat exchanging device is connected to the at least one heat converging path, and a temperature sensor is disposed on the heat exchanging device.

13. The cylindrical lithium-ion battery of claim 12, wherein the at least one heat converging path and the heat exchanging device are connected by welding, bolting, gluing, or riveting.

14. The cylindrical lithium-ion battery of claim 1, wherein each of the at least two heat conducting and collecting bodies comprises an insulating layer on a surface thereof.

15. The cylindrical lithium-ion battery of claim 1, wherein the at least one heat converging path is disposed at an end of the lithium-ion soft battery, and the end of the lithium-ion soft battery having a positive electrode tab, an end of the lithium-ion soft battery opposite to the positive electrode tab, or a side of the lithium-ion soft battery.

16. The cylindrical lithium-ion battery of claim 15, when the at least one heat converging path is more than one, at least one of the heat converging paths is disposed at the end of the lithium-ion soft battery having the positive electrode tab.

17. The cylindrical lithium-ion battery of claim 1, wherein each of the at least two heat conducting and collecting bodies protrudes from the positive electrode plate, and portions of the at least two heat conducting and collecting bodies which protrude from the positive electrode plate are inserted into an electrolyte of the cylindrical lithium-ion battery.

18. The cylindrical lithium-ion battery of claim 1, wherein a heat exchanging device is disposed in an electrolyte of the cylindrical lithium-ion battery for heating or cooling the electrolyte.

19. The cylindrical lithium-ion battery of claim 1, wherein the at least two heat conducting and collecting bodies are recessed with respect to the negative electrode plate, an interconnecting portion is formed between the at least two heat conducting and collecting bodies and the negative electrode plate, a thickness of an entirety of each of the at least two heat conducting and collecting bodies is same as of a thickness of the interconnecting portion.

20. The cylindrical lithium-ion battery of claim 1, wherein a temperature sensor is disposed on the at least one heat converging path.
